(19) United States
(12) Patent Application Publication
(10) Pub. No.: US 2008/0041911 A1
(43) Pub. Date: Feb. 21, 2008

(54) Powder actuated tool with safety trigger lock device

(76) Inventor: Cheng-Ho Lee, Hsintien City (TW)

Correspondence Address: Cooper & Dunham LLP, 1185 Avenue of the Americas, New York, NY, 10036, US

(21) Appl. No.: 11/500,119

(22) Filed: Aug. 7, 2006

(51) Int. Cl. B25C 1/08

(52) U.S. Cl. 227/9; 102/531

(57) ABSTRACT

A powder actuated tool with a safety trigger lock device has a handle assembly, a barrel assembly and a switch. The handle assembly has a trigger. The trigger is mounted pivotally in the handle assembly and has an actuating edge. The barrel assembly is mounted in the handle assembly and has a firing mechanism and a sear corresponding to the trigger. The switch has an actuating rod mounted rotatably in a handle assembly and has a surface and a recess. The recess is defined in the surface of the actuating rod and selectively receives the actuating edge of the trigger. Users can turn the switch to make the recess receives the actuating edge of the trigger to allow the trigger pivoting or to make the surface of the actuating rod abut the actuating edge of the trigger to keep the trigger from pivoting.

### BACKGROUND OF THE INVENTION

1. Field of the Invention

The present invention relates to a powder actuated tool that further includes a safety trigger lock device to ensure the safety of using the powder actuated tool.

2. Description of Related Art

A conventional powder actuated tool generally includes a handle, a trigger and a barrel. The trigger is mounted pivotally beside the handle. The barrel connects securely to the handle and has a main passage. The main passage is defined in the barrel and communicates to a firing mechanism containing powder and comprising a sear. Such that fasteners installed in the conventional powder actuated tool can be shot through the main passage to fasten a board onto a surface when the trigger hits the sear to initiate the firing mechanism.

Recently, powder actuated tools are widely used because of their convenience. However, the conventional powder actuated tools do not include any safety trigger lock device to keep the tools from inadvertently discharging. Consequently, unauthorized people or even children with access to the powder actuated tool can depress the tool, pull the trigger and shoot fasteners to cause injury or other damage. Furthermore, when a conventional powder actuated tool drops to the ground, it will sustain a shock that could readily activate the trigger unintentionally to hit the sear. As a result, the powder actuated tool shoots fasteners and causes a very dangerous situation with regard to people and property.

To overcome the shortcomings, the present invention provides a powder actuated tool with a safety trigger lock device to obviate or mitigate the aforementioned problems.

### SUMMARY OF THE INVENTION

The main objective of the present invention is to provide a powder actuated tool with a safety trigger lock device to prevent occurrence of danger or injury of users. To achieve the objective, the powder actuated tool in accordance with the present invention comprises a handle assembly, a barrel assembly and a switch. The handle assembly has a trigger. The trigger is mounted pivotally in the handle assembly and has an actuating edge. The barrel assembly is mounted in the handle assembly and has a firing mechanism and a sear corresponding to the trigger. The switch has an actuating rod mounted rotatably in the handle assembly and has a surface and a recess. The recess is defined in the surface of the actuating rod and selectively receiving the actuating edge of the trigger.

When the switch is turned to safe mode, the recess does not receive the actuating edge of the trigger and the actuating rod keeps the trigger from pivoting so that the fasteners cannot be shot. When the switch is turned to fire mode, the recess receives the actuating edge of the trigger to allow the trigger to be pivoted to hit the sear for shooting fasteners.

Other objectives, advantages and novel features of the invention will become more apparent from the following detailed description when taken in conjunction with the accompanying drawings.

### BRIEF DESCRIPTION OF THE DRAWINGS

FIG. 1 is an exploded perspective view of a powder actuated tool with a safety trigger lock device in accordance with the present invention;

FIG. 2 is a partially side view in partial section of the powder actuated tool in FIG. 1;

FIG. 3 is an operational side view of the powder actuated tool in FIG. 1;

FIG. 4 is a partially side view in partial section of the powder actuated tool in FIG. 1 showing the surface of the actuating rod abutting the actuating edge of the trigger to keep the trigger from pivoting; and

FIG. 5 is an operational partially side view of the powder actuated tool in FIG. 1.

### DETAILED DESCRIPTION OF THE PREFERRED EMBODIMENT

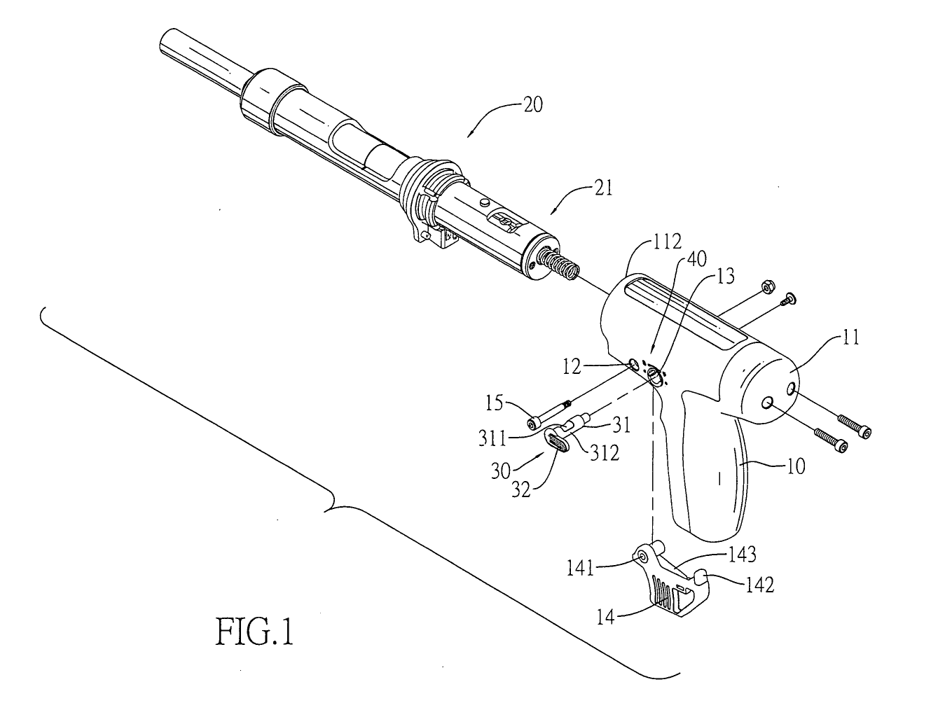

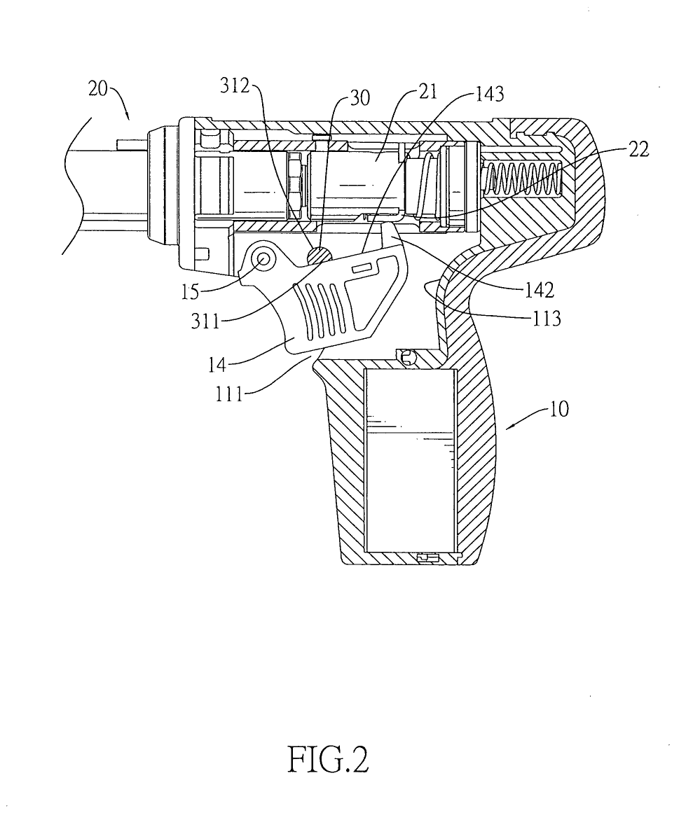

With reference to FIGS. 1 and 2, the powder actuated tool with a safety trigger lock device in accordance with the present invention comprises a handle assembly (10), a barrel assembly (20) and a switch (30).

The handle assembly (10) has a bottom portion, a top portion (11), a notch (111), a space (113), a trigger (14), a pintle (15) and two signs (40). The notch (111) is formed in the bottom portion near the top portion (11) of the handle assembly (10). The top portion (11) is formed perpendicularly on the bottom portion of the handle assembly (10) and has a front end, an opening (112), a pivoting hole (12), a rotating hole (13). The opening (112) is defined in the front end of the top portion (11) of the handle assembly (10). The pivoting hole (12) is defined in the top portion (11) of the handle assembly (10) near the notch (111) of the handle assembly (10). The rotating hole (13) is defined in the top portion (11) between the pivoting hole (12) and the notch (111 ) of the handle assembly (10). The space (113) is defined in the top portion (11) and the bottom portion of the handle assembly (10) and communicates with the opening (112) and the notch (111). The trigger (14) is mounted pivotally through the notch (111) in the space (113) of the handle assembly (10) and has a top with a proximal end and a distal end, a through hole (141), a protrusion (142) and an actuating edge (143). The through hole (141) is defined through the proximal end of the top of the trigger (14) corresponding to the pivoting hole (12) of the handle assembly (10). The protrusion (142) is formed on the distal end of the top of the trigger (14). The actuating edge (143) is defined on the top of the trigger (14) between the proximal end and the distal end of the trigger (14). The pintle (15) is mounted in the through hole (141) of the trigger (14) and has a threaded end. The threaded end of the pintle (15) extends into the pivoting hole (12) of the handle assembly (10) and is mounted securely in the space (113) of the handle assembly (10) to allow the trigger (14) pivoting relative to the handle assembly (10). The signs (40) are defined on the top portion (11) of the handle assembly (10) respectively beside the rotating hole (13) and display an “S” and an “F”, wherein the “S” means safe mode and the “F” means fire mode.

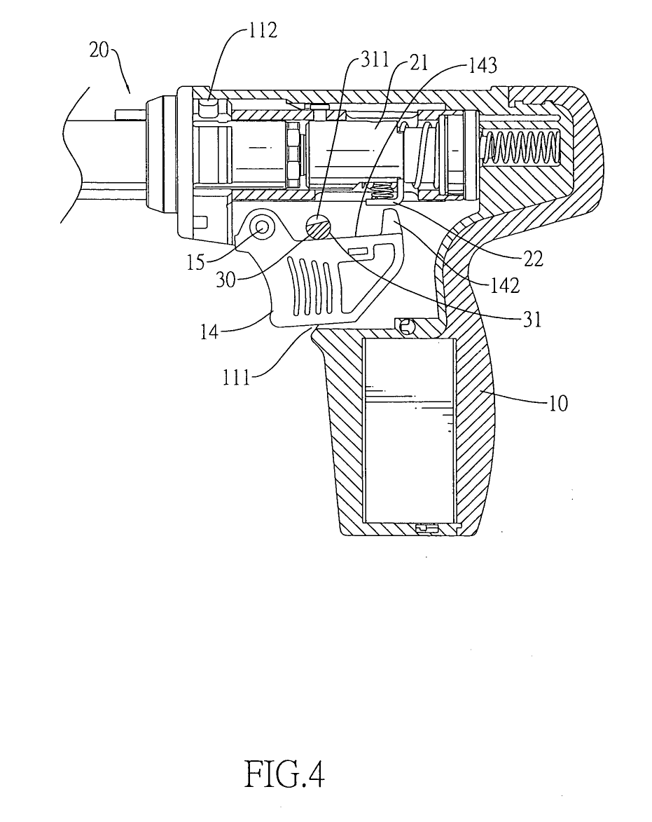

With further reference to FIG. 4, the barrel assembly (20) is mounted securely in the handle assembly (10), is tubular and has a distal end, a proximal end, a firing mechanism (21) and a sear (22). The distal end of the barrel assembly (20) has an outlet. The proximal end is received in the opening (112) of the handle assembly (10). The firing mechanism (21) contains powder therein and is mounted on the proximal end of the barrel assembly (20). The sear (22) is mounted on the firing mechanism (21) corresponding to the protrusion (142) of the trigger (14).

The switch (30) is mounted rotatably in the handle assembly (10) and has an actuating rod (31) and a control rod (32). The actuating rod (31) is mounted rotatably in the rotating hole (13) of the handle assembly (10) and has a surface (312) and a recess (311). The recess (311) is defined in the surface (312) of the actuating rod (31) and selectively receives the actuating edge (143) of the trigger (14). The control rod (32) is formed on the actuating rod (31), extends out of the rotating hole (13) of the handle assembly (10), is mounted between the signs (40) on the handle assembly (10) and has an arrow point. The arrow point selectively points to one of the two signs (40).

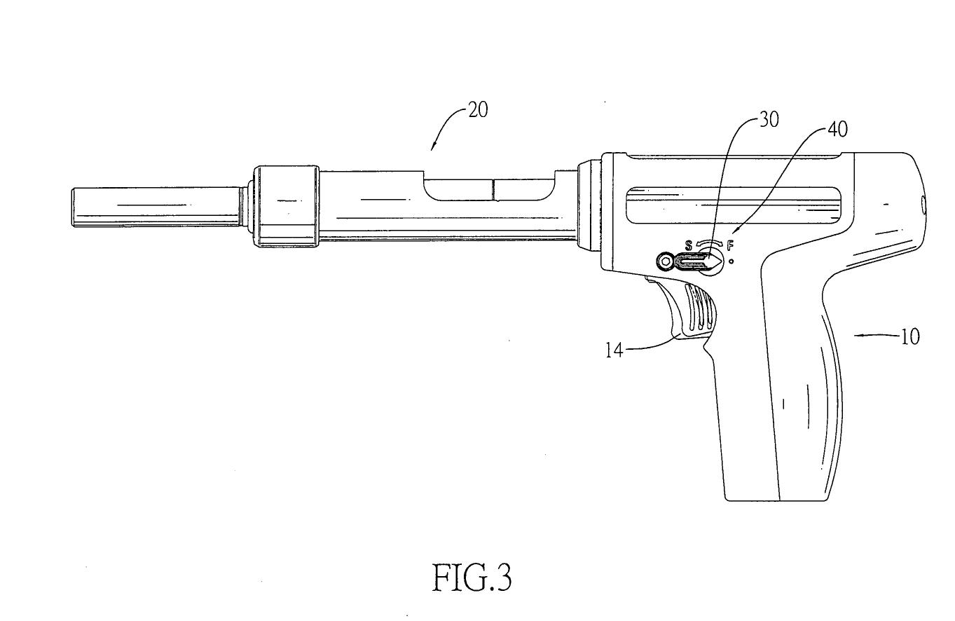

With reference to FIGS. 1, 2 and 3, when the arrow point of the control rod (32) of the switch (30) is turned to point the sign (40) of fire mode on the handle assembly (10), the recess (311) is opposite to and ready for receiving the actuating edge (143) of the trigger (14). Then, the trigger (14) can be pulled by a user to pivot relative to the handle assembly (10) to make the protrusion (142) hit the sear (22) and shoot fasteners.

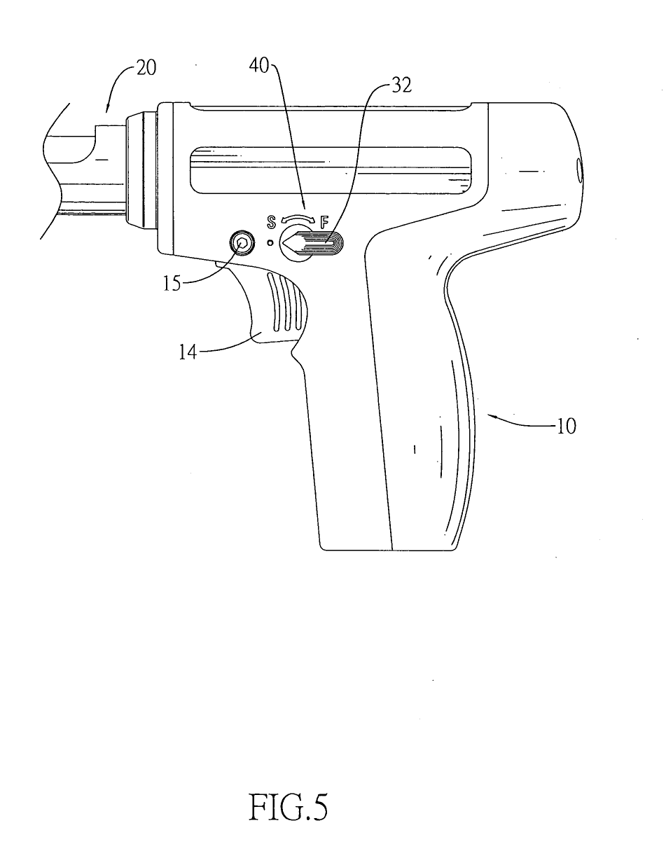

With reference to FIGS. 1, 4 and 5, when the arrow point of the control rod (32) of the switch (30) is turned to point the sign (40) of safe mode, the recess (311) is not opposite to the actuating edge (143) of the trigger (14). When the trigger (14) is pivoted, the surface (312) of the actuating rod (31) of the switch (30) may abut the actuating edge (143) of the trigger (14) to keep the trigger (14) from rotating, such that the trigger (14) cannot be pivoted to shoot the fasteners.

By such an arrangement of the powder actuated tool in accordance with the present invention, unintentionally discharging because of unauthorized people, children or dropping can be effectively prevented.

Even though numerous characteristics and advantages of the present invention have been set forth in the foregoing description together with details of the structure and function of the invention, the disclosure is illustrative only. Changes may be made in detail especially in matters of shape, size and arrangement of parts within the principles of the invention to the full extent indicated by the broad general meaning of the terms in which the appended claims are expressed.

What is claimed is:

1. A powder actuated tool with a safety trigger lock device comprising
a handle assembly having
a bottom portion;
a notch being formed in the bottom portion of the handle assembly;
a top portion being formed on the bottom portion of the handle assembly and having
a front end;
a pivoting hole being defined in the top portion near the notch of the handle assembly;
an opening being defined in the front end of the top portion; and
a rotating hole being defined in the top portion between the pivoting hole and notch of the handle assembly;
a space being defined in the bottom and top portions of the handle assembly and communicating with the opening and the notch
a trigger being mounted pivotally in the notch of the handle assembly and having
a top having
a proximal end being mounted pivotally with the pivoting hole of the top portion; and
a distal end;
a protrusion being formed on the distal end of the top of the trigger; and
an actuating edge being defined on the top of the trigger between the proximal end and the distal end of the top of the trigger;
a barrel assembly mounted securely in the handle assembly and having
a proximal end being received in the opening of the handle assembly;
a firing mechanism mounted on the proximal end of the barrel assembly; and
a sear mounted on the firing mechanism corresponding to the protrusion of the trigger; and
a switch mounted rotatably in the handle assembly and having
an actuating rod being mounted rotatably in the rotating hole of the handle assembly and having
a surface; and
a recess being defined in the surface of the actuating rod and selectively receiving the actuating edge of the trigger; and
a control rod being formed on the actuating rod, extending out of the rotating hole of the handle assembly.

2. The powder actuated tool as claimed in claim 1, wherein
the trigger further has a through hole being defined through the proximal end of the top of the trigger and corresponding to the pivoting hole; and
a pintle is mounted in the through hole of the trigger and has an end secured in the space of the handle assembly to allow the trigger pivot in the notch of the handle assembly.

3. The powder actuated tool as claimed in claim 2, wherein
the handle assembly further comprises two signs being defined on the top portion of the handle assembly respectively beside the rotating hole; and
the control rod is mounted between the signs on the handle assembly and having an arrow point selectively pointing to one of the two signs.

4. The powder actuated tool as claimed in claim 3, wherein the end of the pintle is threaded and is extending into the pivoting hole and mounted securely in the space of the handle assembly.

5. The powder actuated tool as claimed in claim 4, wherein the sign displays
an “S” meaning safe mode; and
an “F” meaning fire mode.
